(19) United States
(12) Patent Application Publication
(10) Pub. No.: US 2003/0169286 A1
(43) Pub. Date: Sep. 11, 2003

(54) Apparatus for controlling display of index images

(76) Inventor: Takeshi Misawa, Asaka-shi (JP)

Correspondence Address: BIRCH STEWART KOLASCH & BIRCH, PO BOX 747, FALLS CHURCH, VA, 22040-0747, US

(21) Appl. No.: 10/384,642

(22) Filed: Mar. 11, 2003

(30) Foreign Application Priority Data
Mar. 11, 2002 (JP) 2002-064722

(51) Int. Cl. G09G 5/00

(52) U.S. Cl. 345/716

(57) ABSTRACT

An index image display area having a plurality of thumbnail image display areas is displayed on a display screen. The greater the distance transversely from a centrally located thumbnail image display area, the smaller the widths of the thumbnail image display areas become. A full image of single frame is displayed in the center thumbnail image display area, and only portions of thumbnail images are displayed in the other thumbnail image display areas. This makes it possible to display a large number of thumbnail images.

### BACKGROUND OF THE INVENTION

1. Field of the Invention

This invention relates to an index-image display control apparatus for controlling a display unit so as to display images of a plurality of frames.

2. Description of the Related Art

A personal computer reads image data representing images of a plurality of frames recorded on a hard disk and is capable of displaying thumbnail images of these images, which are represented by the image data, in the form of an array-type list. If a desired thumbnail image is found, the thumbnail image is clicked, whereupon the corresponding image is displayed in a size larger than that of the thumbnail image.

Such a display of thumbnail images arrayed in list form is possible not only with a personal computer but also with a digital still camera. Thumbnail images are displayed in list form on a liquid crystal display screen provided on the back of the digital still camera.

However, since a digital still camera in particular is required to be small in size, the liquid crystal display screen is also small in size. This means that the number of image frames that can be displayed in list form is small.

### SUMMARY OF THE INVENTION

Accordingly, an object of the present invention is to so arrange it that a comparatively large number of images can be displayed.

According to the present invention, the foregoing object is attained by providing an apparatus for controlling display of index images, comprising a first display controller (first display control means) for controlling a display device so as to display an image display strip on a display screen, the image display strip including a plurality of mutually adjacent image display areas the sizes of which diminish in accordance with direction along the image display strip (which may be longitudinal or transverse) as distance from one of the image display areas (e.g., an image display area located at the center of the image display strip) increases; an image data reading device for reading a plurality of frames of image data that have been recorded on a recording medium; and a second display controller (second display control means) for controlling the display device in such a manner that a plurality of frames of images represented by the plurality of frames of image data, which have been read by the image data reading device, are displayed in corresponding ones of the image display areas of the image display strip (part of the image of one frame may be displayed in an image display area or compression may be applied in such a manner that the entirety of the image of one frame will be displayed in an image display area).

The present invention provides also a method suited to the above-described apparatus for controlling the display of index images. Specifically, the method comprises the steps of displaying an image display strip on a display screen, the image display strip including a plurality of mutually adjacent image display areas the sizes of which diminish in accordance with direction along the image display strip as distance from one of the image display areas increases; reading a plurality of frames of image data that have been recorded on a recording medium; and displaying a plurality of frames of images, which are represented by the read plurality of frames of image data, in corresponding ones of the image display areas of the image display strip.

A program for implementing the above method and a recording medium on which the program ahs been stored may be provided.

In accordance with the present invention, an image display strip is displayed on a display screen. The image display strip includes a plurality of mutually adjacent image display areas the sizes of which diminish in accordance with direction along the image display strip as distance from one of the image display areas increases. A plurality of frames of images represented by image data of a plurality of frames read from a recording medium are displayed in corresponding ones of the image display areas of the image display strip. (The images displayed in the image display areas may be the corresponding thumbnail images. When a thumbnail image is displayed, generating means would be provided for generating thumbnail image data representing the thumbnail image from the image data that has been read.)

Since the sizes of the image display areas become progressively smaller in accordance with direction along the image display strip, the number of image frames that can be displayed increases. A comparatively large number of image frames can be displayed even if the size of the display screen is not large.

The apparatus may further be provided with a reducing device (reducing means) for reducing the image data of the plurality of frames, which have been read by the image data reading device, in such a manner that the sizes of the images displayed in the image display areas are reduced along the direction of the image display strip. In this case, the second display controller would display thumbnail images, which are represented by the image data reduced by the reducing device, in the corresponding image display areas.

The image display strip may be ring-shaped. In such case the apparatus is further provided with a scroll command input device and a third display controller (third display control means) for controlling the display device, in response to entry of a scroll command from the scroll command input device, in such a manner that images to be displayed in the image display areas are displayed one after another in mutually adjacent image display areas. As a result, the fact that image data representing a number of images has been recorded on a recording medium can be understood intuitively.

The second display controller may control the display device in such a manner that a part of image is displayed on the image display area.

Preferably, the part of image may include a center portion of the image.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical structure of a digital still camera according to a preferred embodiment of the present invention;

FIG. 2 is a diagram illustrating a main image display area and an index image display area displayed on a display screen of the camera;

FIG. 3 is a diagram illustrating thumbnail images displayed in the index image display areas;

FIG. 4 is a flowchart illustrating processing executed in a playback mode;

FIGS. 5 to 9 are diagrams illustrating examples of images displayed on the display screen;

FIG. 10 is a diagram illustrating thumbnail images displayed in the index image display areas according to a modification of the embodiment;

FIG. 11 is a flowchart illustrating processing executed in a playback mode according to the modification;

FIG. 12 is a diagram illustrating examples of images displayed on the display screen according to the modification;

FIG. 13 is a diagram illustrating thumbnail images displayed in the index image display areas according to another modification of the embodiment;

FIG. 14 is a flowchart illustrating processing executed in a playback mode according to this other modification;

FIG. 15 is a diagram illustrating examples of images displayed on the display screen according to this other modification;

FIG. 16 is a diagram illustrating examples of images displayed on the display screen according to yet another modification of the embodiment; and

FIG. 17 is a flowchart illustrating processing executed in a playback mode according to this other modification.

### DESCRIPTION OF THE PREFERRED EMBODIMENT

A preferred embodiment of the present invention will now be described in detail with reference to the drawings.

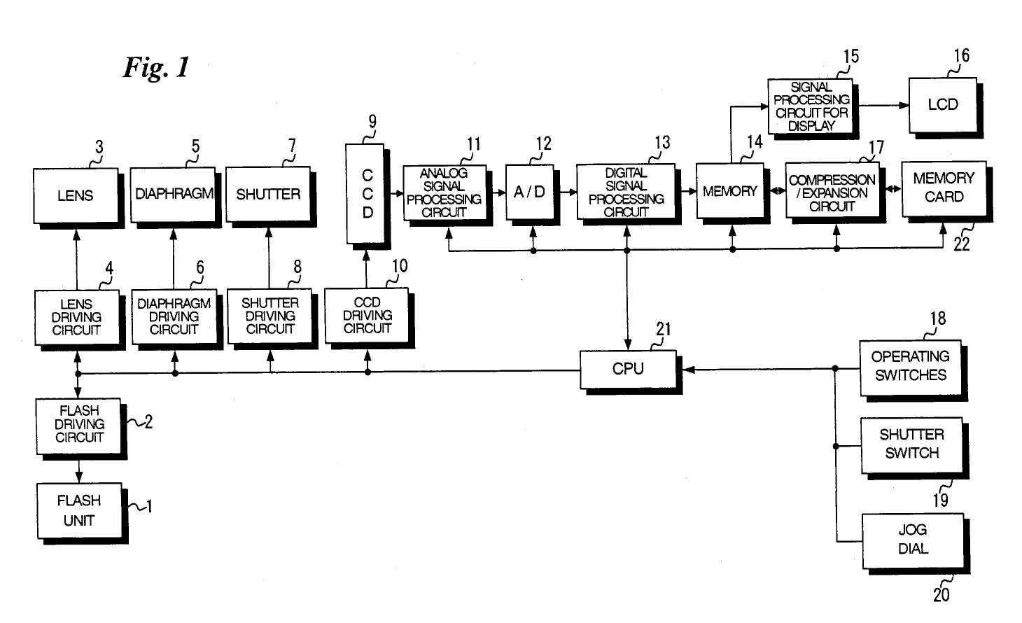

FIG. 1 is a block diagram showing the electrical structure of a digital still camera illustrative of a preferred embodiment of the present invention.

The overall operation of the digital still camera is controlled by a CPU 21.

The digital still camera includes operating switches 18 and a shutter switch 19. The operating switches 18 include a mode switch for setting various modes such as a still-picture imaging mode and a playback mode, a frame-advance button for applying a playback frame-advance command and a frame-back button for applying a playback frame-back command. Output signals from the operating switches 18 and shutter switch 19 are input to the CPU 21.

An arrangement may be adopted in which the digital still camera is provided with freely rotatable jog dial 20 that is capable of applying commands such as the frame-advance command and frame-back command continuously. A signal indicating degree of rotation output from the jog dial 20 also is input to the CPU 21.

The digital still camera is provided with a liquid crystal display unit 16. Camera angle or the like is decided by displaying the image of a subject on the display screen of the liquid crystal display unit 16.

The digital still camera is capable of electronic flash photography and therefore includes a flash unit 1 and a flash driving circuit 2 for controlling the emission of light from the flash unit 1.

The digital still camera is provided with a zoom lens 3, diaphragm 5 and shutter 7. The zoom lens 3, diaphragm 5 and shutter 7 are controlled by a lens driving circuit 4, diaphragm driving circuit 6 and shutter driving circuit 8, respectively. The digital still camera includes a CCD 9 controlled by a CCD driving circuit 10.

When the imaging mode (still-picture imaging mode or a memo imaging mode) is set, the image of the subject is formed on the photoreceptor surface of the CCD 9 and a video signal representing the image of the subject is input to an analog signal processing circuit 11. The latter executes predetermined analog signal processing such as a gamma correction processing and white balance adjustment processing. The video signal output from the analog signal processing circuit 11 is converted to digital image data in an analog/digital converter circuit 12, whence the digital image data is input to a digital signal processing circuit 13. The latter executes predetermined digital signal processing such as generation of luminance data Y and color-difference data R-Y and B-Y. The image data output from the digital signal processing circuit 13 is applied to and stored temporarily in a memory 14.

The image data is read out of the memory 14 and input to a signal processing circuit 15 for display purposes. The latter executes pixel downsampling processing so as to display images on the liquid crystal display unit 16, as well as other signal processing. Image data that is output from the signal processing circuit 15 is applied to the liquid crystal display unit 16, whereby the image obtained by imaging is displayed on the display screen of the liquid crystal display unit 16.

If the shutter switch 19 is pressed, the image data that has been stored in the memory as described above is input to a compression/expansion circuit 17. The latter performs data compression such as compression in accordance with the JPEG (Joint Photographic Experts Group) standard. The compressed image data is applied to and recorded on a memory card 22.

When the playback mode is set, compressed image data that has been recorded on the memory card 22 is read and is then expanded by the compression/expansion circuit 17. The expanded image data is applied to the memory 14 and in memory 14 temporarily. Image data that has been stored in the memory 14 is read and applied to the signal processing circuit 15. The image represented by the image data that has been recorded on the memory card 22 is displayed on the display screen of the liquid crystal display unit 16.

Thumbnail image data also has been recorded on the memory card 22 and thumbnail images can be displayed in at-a-glance form on the display screen of the liquid crystal display unit 16 in a manner described later. In a case where thumbnail image data has not been recorded on the memory card 22, this data would be generated by the CPU 21.

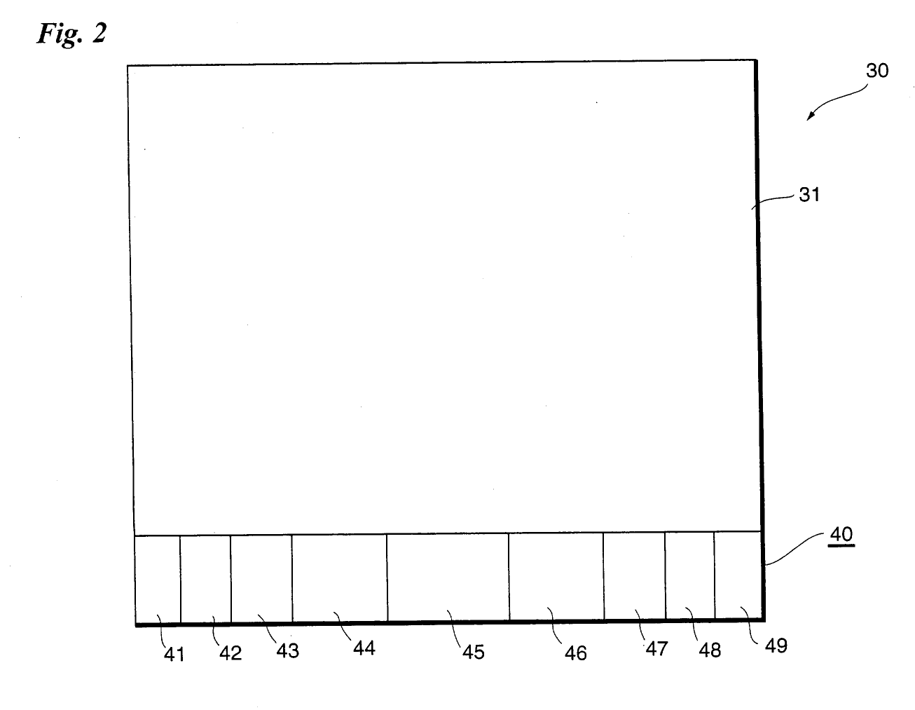

FIG. 2 illustrates the display screen of the liquid crystal display unit 16.

In this embodiment, a main image display area 31 and an index image display area (thumbnail image display area strip) 40 appear on a display screen 30 when the playback mode is set by the mode setting switch.

The main image display area 31 is formed substantially over the entirety of the display screen 30.

The index image display area 40 is formed below the display screen 30 and has a number of thumbnail image display areas 41 to 49. The thumbnail image display areas 41 to 49 are of equal height but the widths thereof diminish with distance from the center thumbnail image display area 45 in the transverse direction. As a result, a greater number of thumbnail image display areas are included in comparison with a case where all of the thumbnail image display areas that constitute the index image display area 40 have a size the same as that of the center thumbnail image display area 45. Accordingly, thumbnail images of a large number of frames can be displayed.

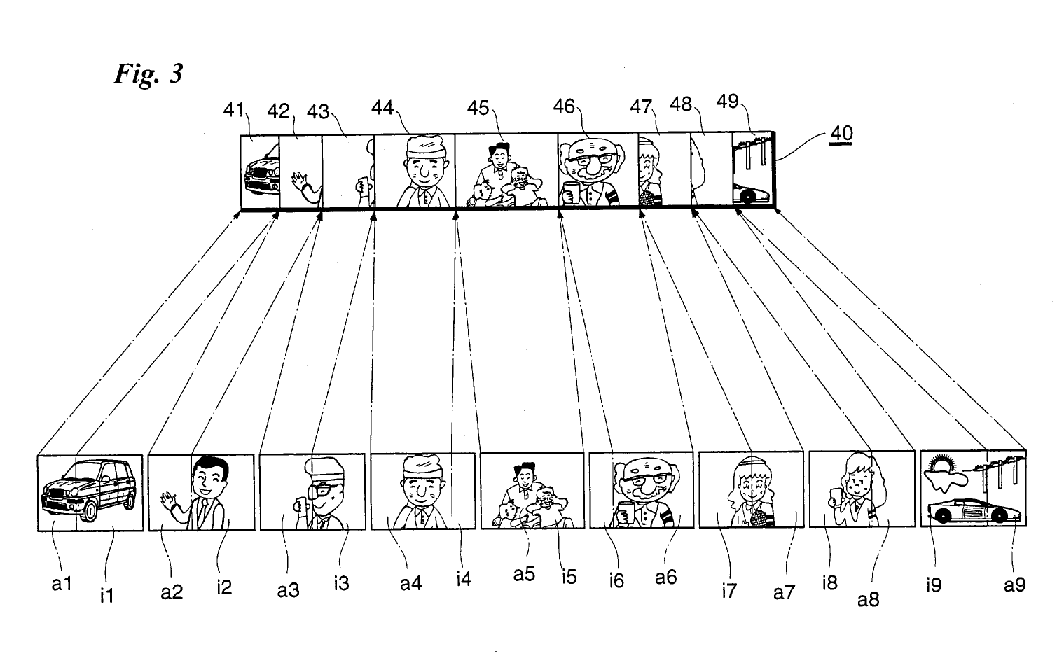

FIG. 3 illustrates the relationship between the image display areas of the index image display area 40 and thumbnail images displayed in these image display areas.

As set forth above, the thumbnail image display areas that make up the index image display area 40 become progressively smaller in width as distance from the center thumbnail image display area 45 increases in the transverse direction. In this embodiment, the full image of a thumbnail image i5 of a single frame is displayed in the center thumbnail image display area 45. As distance from the center thumbnail image display area 45 increases, however, the portions of the images displayed in the thumbnail image display areas become progressively smaller.

Positioning for display of images is performed in the thumbnail image display areas 41 to 44 on the left side of the center thumbnail image display area 45 in such a manner that the left-hand edges of the thumbnail images will agree with the left-hand edges of the thumbnail image display areas. Of the thumbnail images i1 to i4, therefore, thumbnail image portions a1 to a4 the sizes whereof match the sizes of the thumbnail image display areas 41 to 44, respectively, are displayed in these display areas. Positioning for display of images is performed in the thumbnail image display areas 46 to 49 on the right side of the center thumbnail image display area 45 in such a manner that the right-hand edges of the thumbnail images will agree with the right-hand edges of the thumbnail image display areas. Of the thumbnail images i6 to i9, therefore, thumbnail image portions a6 to a9 the sizes whereof match the sizes of the thumbnail image display areas 46 to 49, respectively, are displayed in these display areas.

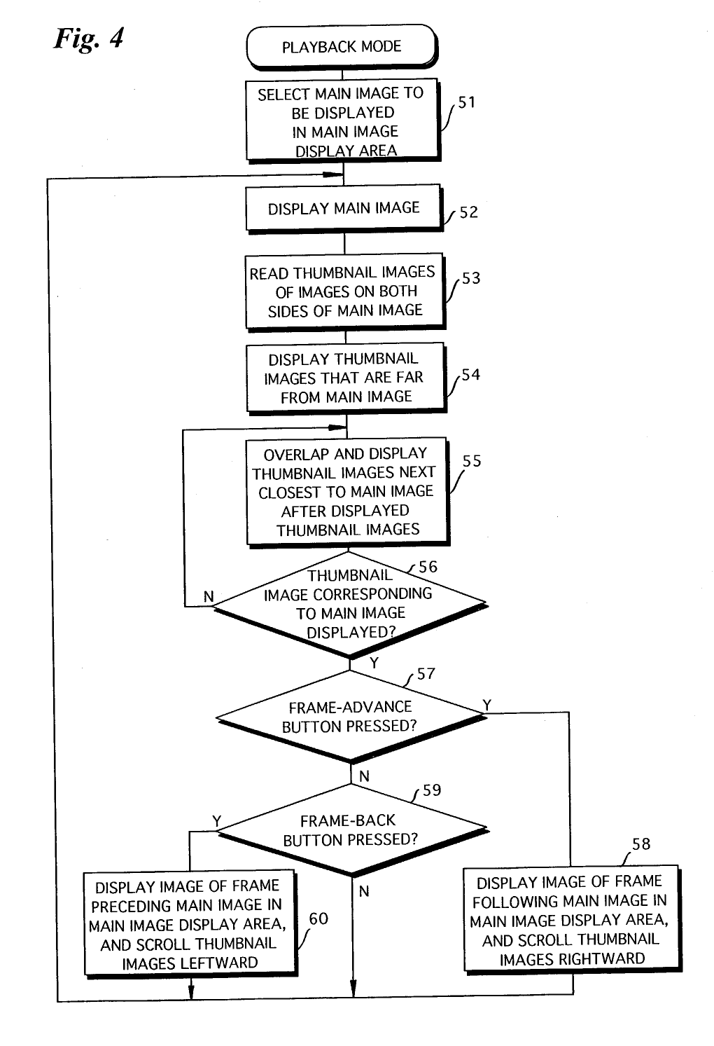

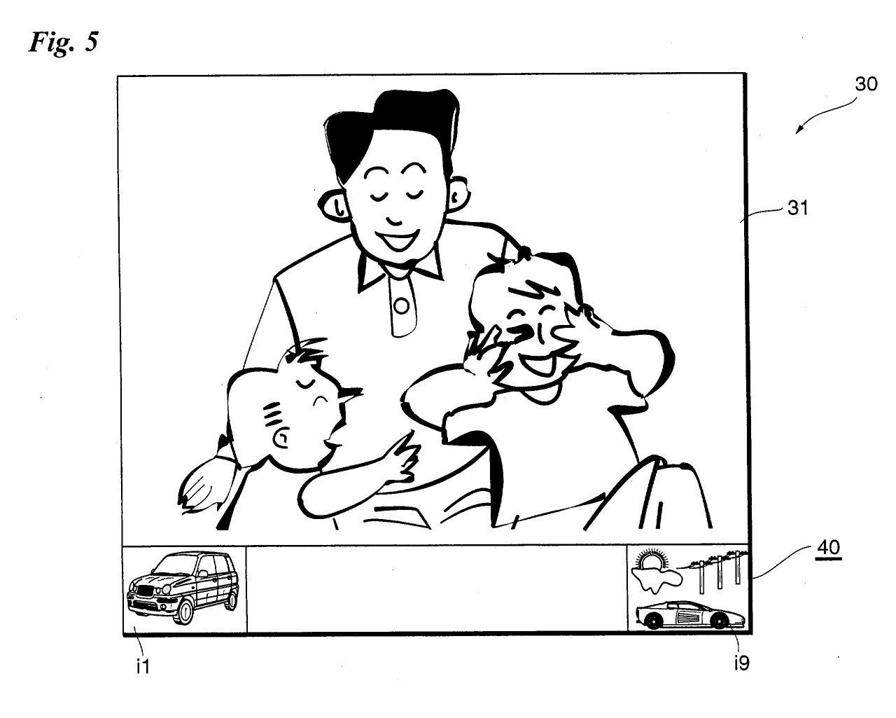

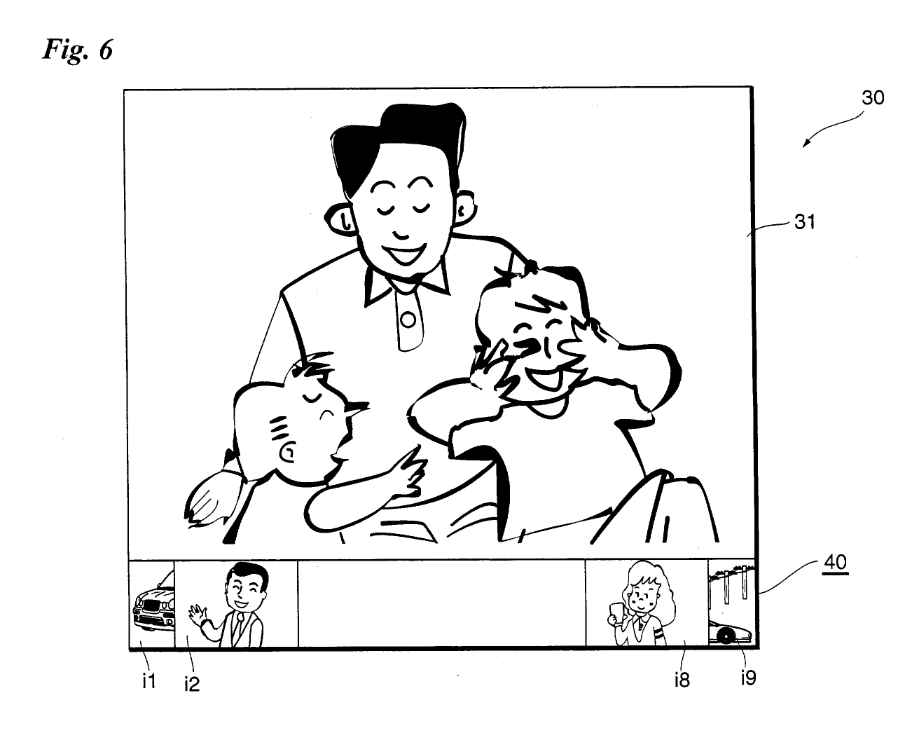

FIG. 4 is a flowchart illustrating processing in the playback mode for displaying portions (or the entirety) of the above-described thumbnail images. FIGS. 5 to 9 illustrate examples of images displayed on the display screen of the liquid crystal display unit.

The processing shown in FIG. 4 starts in response to setting of the playback mode by the mode setting switch. First, an image to be displayed in the main image display area 31 is selected by the user employing the operating switches 18 (step 51). Image data representing the selected image is read out of the memory card 22 and is then applied to the liquid crystal display unit 16 in the manner described above. The selected image (main image) is displayed in the main image display area 31 being displayed on the display screen 30 of the liquid crystal display unit 16 (step 52).

Thumbnail image data representing four frames of thumbnail images i1 to i4 and four frames of thumbnail image i6 to i9 on left and right sides, respectively, of the main image being displayed in the main image display area 31 is read from the memory card 22 (step 53). The thumbnail image data that has been read is applied to the memory 14, where the data is stored temporarily.

Among the thumbnail images represented by the read thumbnail image data, those far from the main image (if frame numbers have been assigned, those thumbnail images having frame numbers far from that of the main image) are displayed at both ends of the index image display area 40 (step 54). If this is the initial display presented in the index image display area 40, then the thumbnail images i1 and i9 will be displayed at the left and right ends, respectively, of the index image display area 40, as illustrated in FIG. 5. Thumbnail images next closest to the main image after these displayed thumbnail images are displayed successively in the index image display area 40 (step 55). Such subsequent thumbnail images are displayed so as to overlap the neighboring thumbnail images already being displayed. The processing of step 55 is repeated until the thumbnail image that corresponds to the selected main image is displayed in the index image display area 40 (step 56).

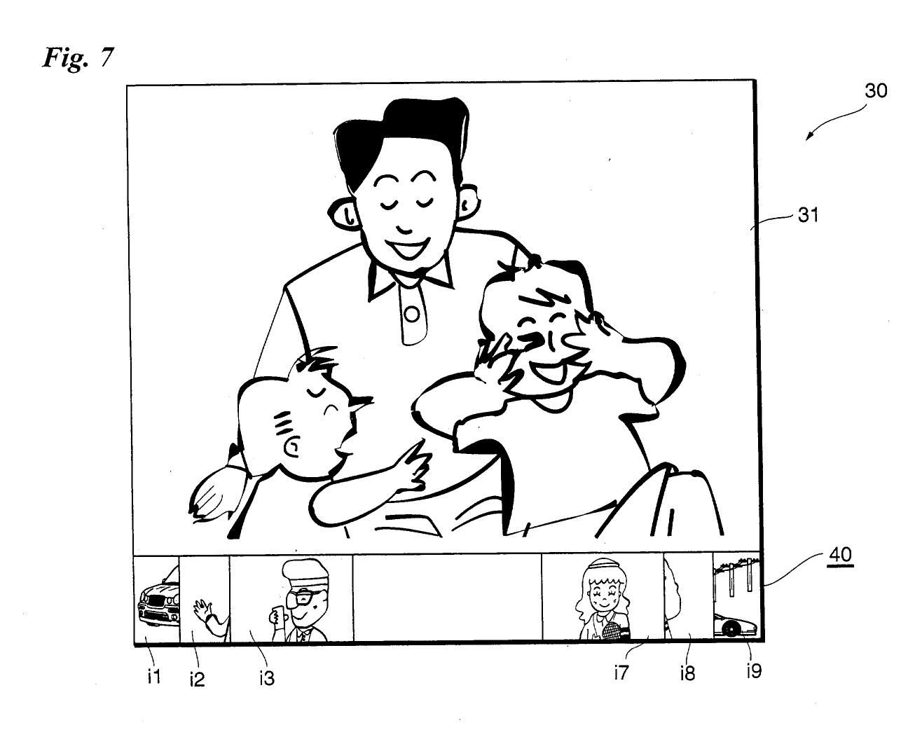

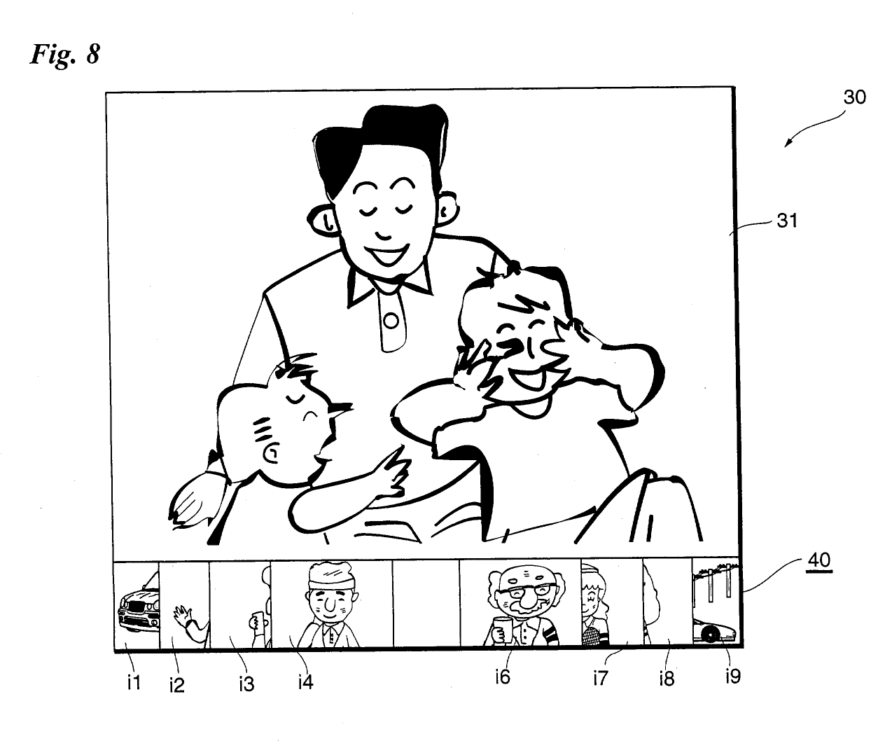

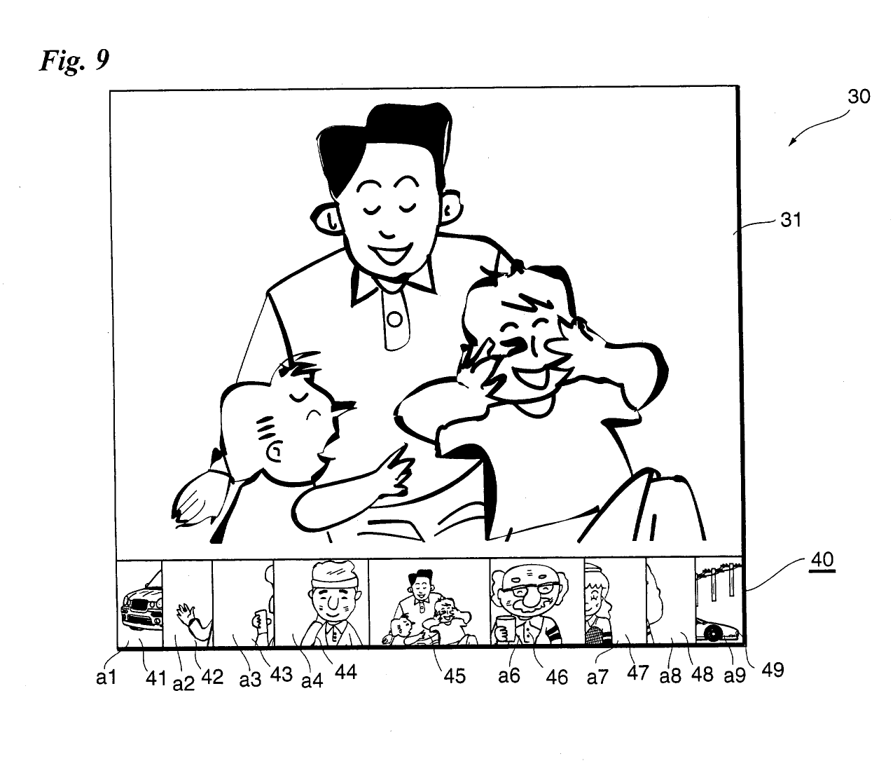

More specifically, if the thumbnail images i1 and i9 are being displayed on the display screen 30, as shown in FIG. 5, the next thumbnail image i2 is displayed in such a manner that the left-hand portion of the image overlaps the thumbnail image i1. Further, the next thumbnail image i8 is displayed in such a manner that the right-hand portion of the image overlaps the thumbnail image i9. The thumbnail images i3 and i7 are displayed in similar fashion inwardly of the thumbnail images i2 and i8, respectively, as depicted in FIG. 7. The thumbnail images i4 and i6 are displayed inwardly of the thumbnail images i3 and i7, respectively, as shown in FIG. 8, and finally the thumbnail image i5 corresponding to the selected main image is displayed at the center, as shown in FIG. 9.

Thus, a large number of thumbnail images are displayed in the index image display area 40. Thumbnail images of a large number of frames can be displayed even if the display screen 30 is small in size, as in the case of a digital still camera.

If the frame-advance button is pressed (“YES” at step 57), the image of the frame that follows the main image being displayed in the main image display area 31 is displayed in the main image display area 31. Further, each thumbnail image being displayed in the index image display area 40 is shifted rightward by one thumbnail image display area (step 58). If the frame-advance button is pressed when the conditions are as shown in FIG. 9, the image that corresponds to thumbnail image i4 being displayed at the left of the center thumbnail image display area 45 will be displayed in the main image display area 31. Further, the thumbnail images i1 to i9 being displayed in the thumbnail image display areas 41 to 49 will be displayed in the thumbnail image display areas 42 to 49 one display area to the right. The thumbnail image i9 is no longer displayed and the thumbnail image that follows the thumbnail image i1 is displayed in the thumbnail image display area 41.

If the frame-back button is pressed (“NO” at step 57, “YES” at step 59), the image of the frame that precedes the main image being displayed in the main image display area 31 will be displayed in the main image display area 31. Further, each of the thumbnail images being displayed in the index image display area 40 is shifted leftward by one thumbnail image display area (step 60). If the frame-back button is pressed when the conditions are as shown in FIG. 9, the image that corresponds to thumbnail image i6 being displayed at the right of the center thumbnail image display area 45 will be displayed in the main image display area 31. Further, the thumbnail images i1 to i9 being displayed in the thumbnail image display areas 41 to 49 will be displayed in the thumbnail image display areas 41 to 48 one display area to the left. The thumbnail image i1 is no longer displayed and the thumbnail image that follows the thumbnail image i9 is displayed in the thumbnail image display area 49.

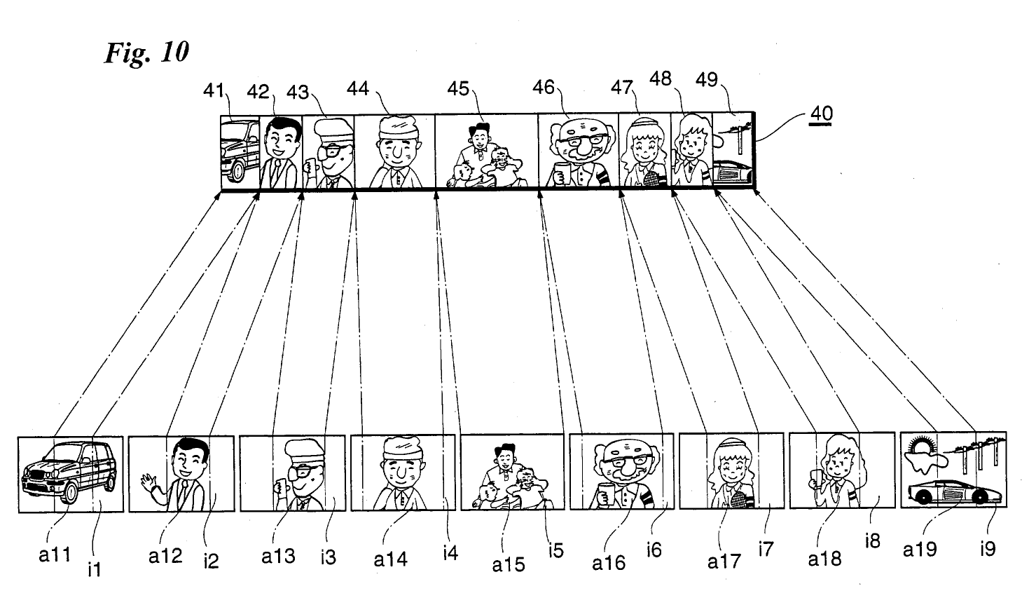

FIGS. 10 to 12 illustrate a modification of the above embodiment.

FIG. 10 is a diagram illustrating the relationship between the image display areas of the index image display area 40 and thumbnail images displayed in these image display areas.

Positioning for display of images is performed in the thumbnail image display areas 41 to 44 and 46 to 49 (namely thumbnail image display areas from which the center thumbnail image display area 45 has been excluded) in such a manner that the central portions of the thumbnail images will coincide with the central portions of the thumbnail image display areas. Of the thumbnail images i1 to i4 and i6 to i9, therefore, thumbnail image portions a11 to a14 and a16 to a19 the sizes whereof match the sizes of the thumbnail image display areas 41 to 44 and 46 to 49, respectively, are displayed in these display areas.

The portion of an image that is important is considered to be located at the center of the image. In this modification, the central portion of a thumbnail image is displayed and therefore the approximate nature of the image can be grasped.

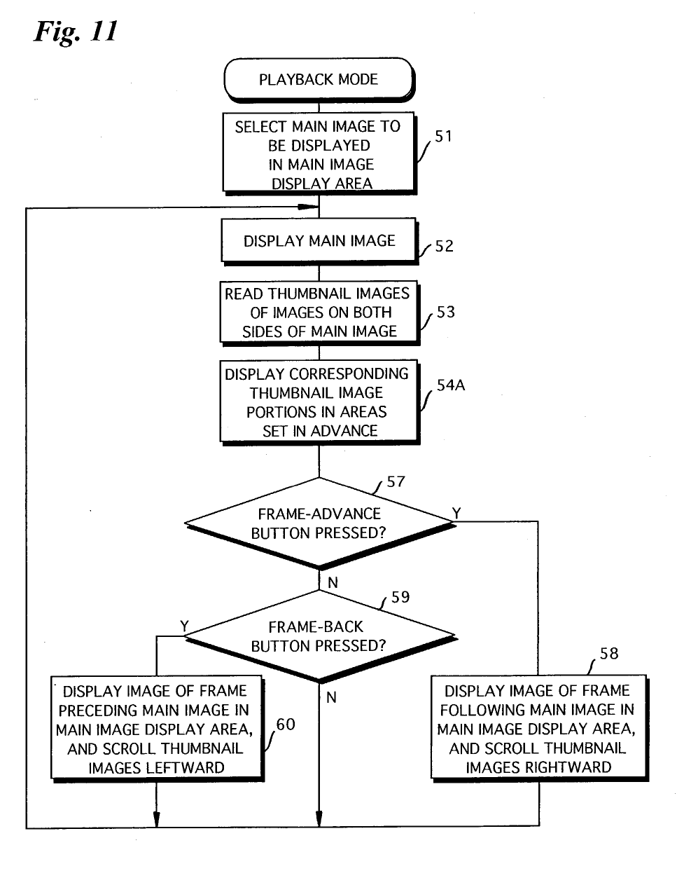

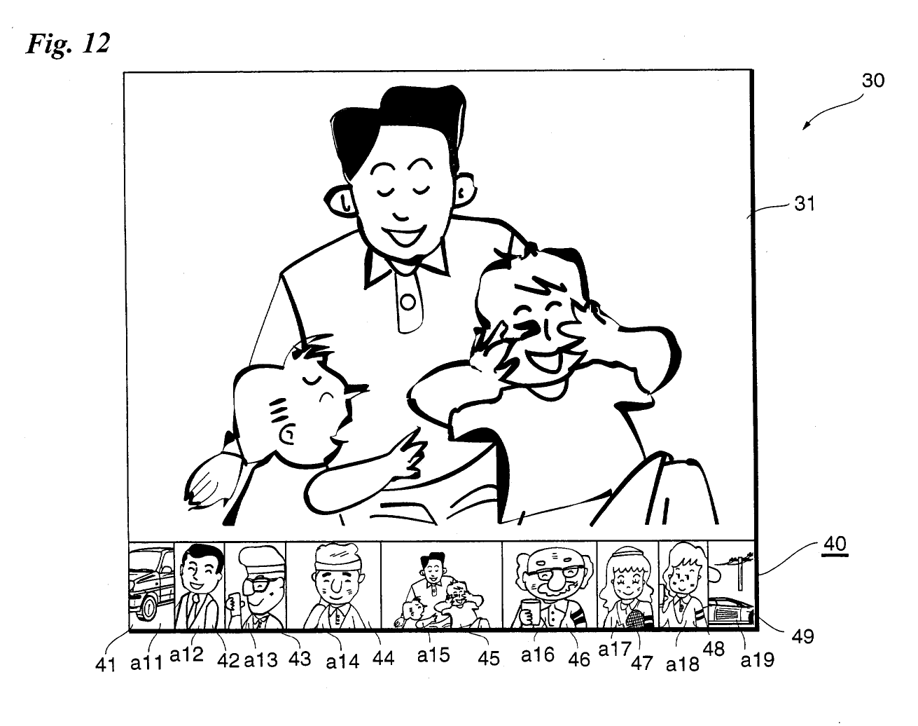

FIG. 11 is a flowchart illustrating processing in the playback mode for displaying the central portions (or the entirety) of the above-described thumbnail images. Processing steps in FIG. 11 identical with those of FIG. 4 are designated by like step numbers and need not be described again. FIG. 12 is a diagram illustrating examples of images displayed on the display screen of the liquid crystal unit.

The processing shown in FIG. 11, besides be devoid of the processing of steps 55 and 56 shown in FIG. 4, has the processing indicated by step 54A instead of the processing indicated by step 54.

When thumbnail image data is read from the memory card 22 (step 53), the images of the central portions set beforehand from among the thumbnail images are displayed in the corresponding thumbnail image display areas 41 to 49 (step 54A). As shown in FIG. 12, image portions all to a19 at the central portions of the thumbnail images i1 to i9 are displayed in the thumbnail image display areas 41 to 49, respectively, constituting the index image display area 40.

Even though the portions making up both sides of an image are not displayed, the central image portion is displayed. This makes it possible grasp the general nature of the image.

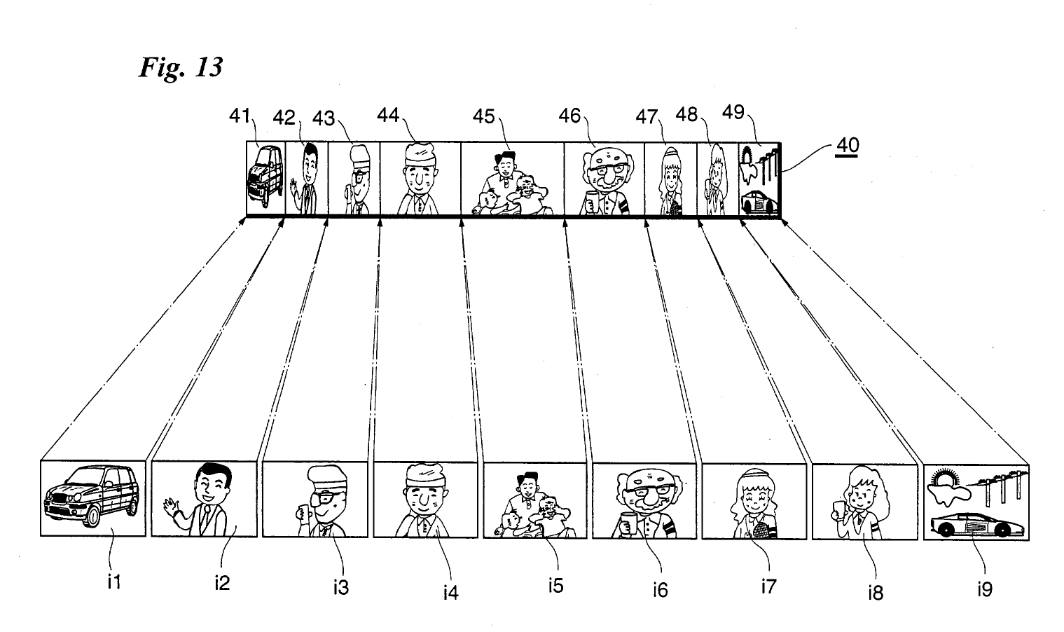

FIGS. 13 to 15 illustrate a second modification of the above embodiment.

FIG. 13 is a diagram illustrating the relationship between the image display areas of the index image display area 40 and thumbnail images displayed in these image display areas.

The thumbnail images i1 to i4 and i6 to i9 displayed in the thumbnail image display areas 41 to 44 and 46 to 49 (namely thumbnail image display areas from which the center thumbnail image display area 45 has been excluded) are reduced in size in such a manner that they will agree with the transverse widths of the thumbnail image display areas 41 to 44 and 46 to 49, respectively. The processing for performing this size reduction can be implemented by downsampling in the transverse direction.

This modification makes it possible to grasp the entirety of each thumbnail image.

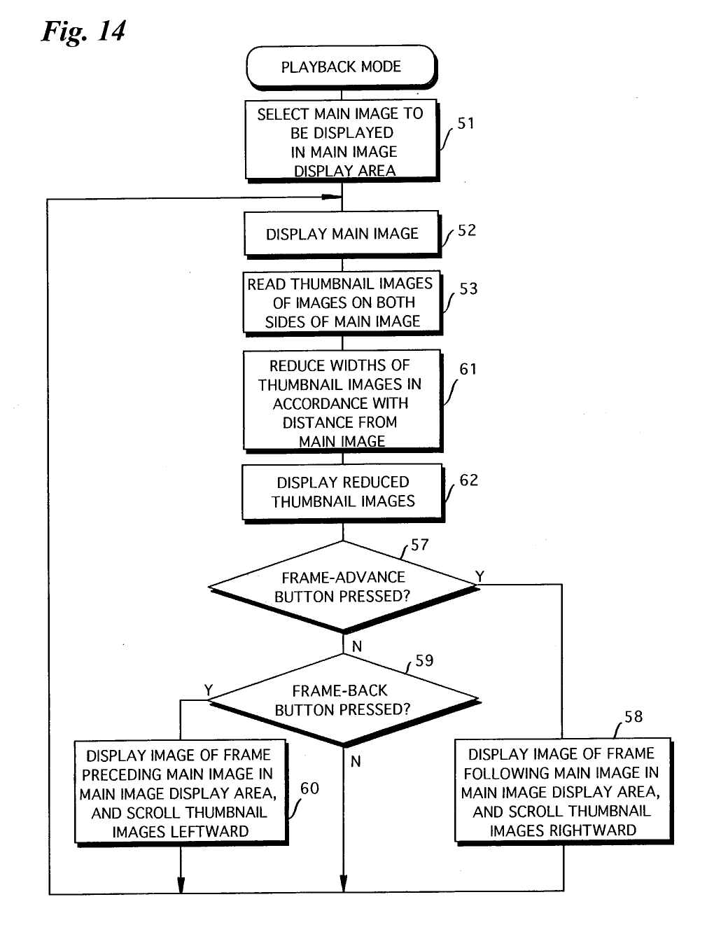

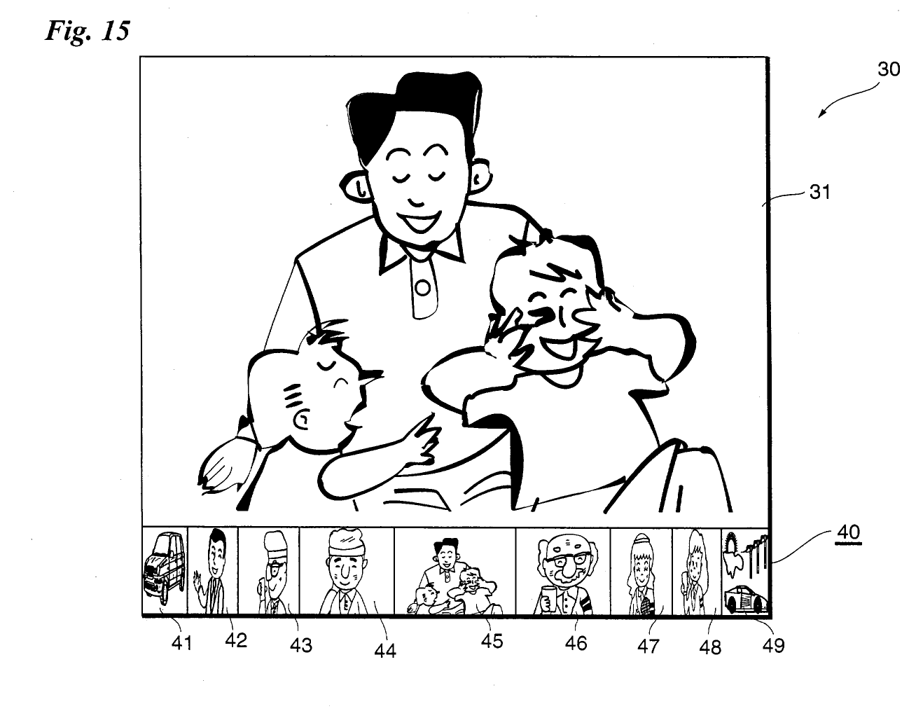

FIG. 14 is a flowchart illustrating processing in the playback mode for displaying the above-described thumbnail images. Processing steps in FIG. 14 identical with those of FIG. 4 are designated by like step numbers and need not be described again. FIG. 15 is a diagram illustrating examples of images displayed on the display screen of the liquid crystal unit.

The processing shown in FIG. 14 has processing indicated by steps 61 and 62 instead of the processing indicated by steps 54 and 55 in FIG. 4.

When thumbnail image data is read from the memory card 22 (step 53), processing for size reduction in the transverse direction is executed in such a manner that the widths of the thumbnail images i1 to i4 and i6 to i9 will take on the widths of the corresponding thumbnail image display areas 41 to 44 and 46 to 49, respectively (step 61). As shown in FIG. 15, the reduced-size thumbnail images i1 to i4 and i6 to i9 are displayed in the corresponding thumbnail image display areas 41 to 44 and 46 to 49 (step 62). The thumbnail image i5, which has not undergone the transverse-direction size reduction, is displayed in the center thumbnail image display area 45.

Thus, the entire images can be ascertained.

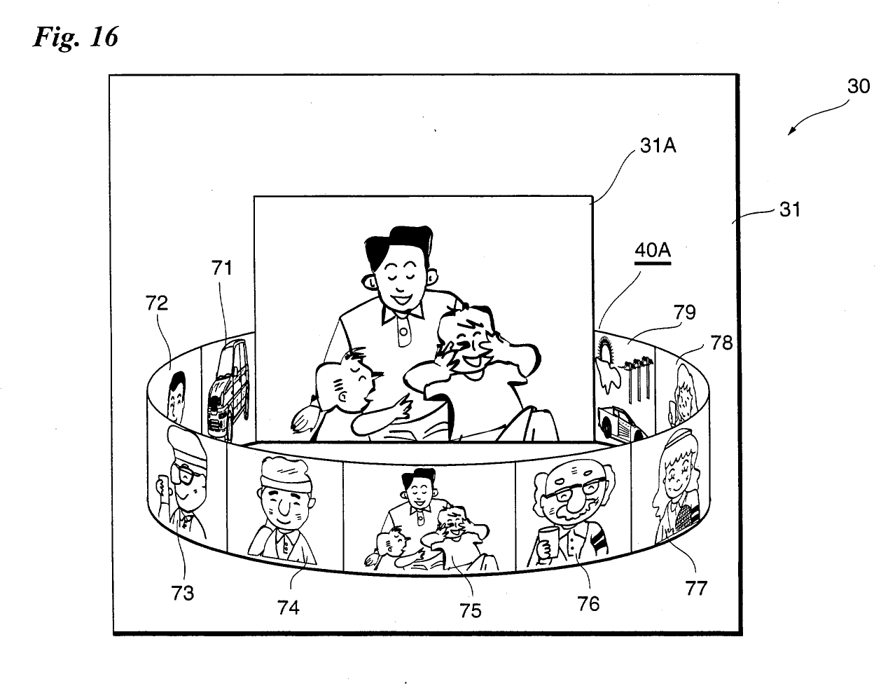

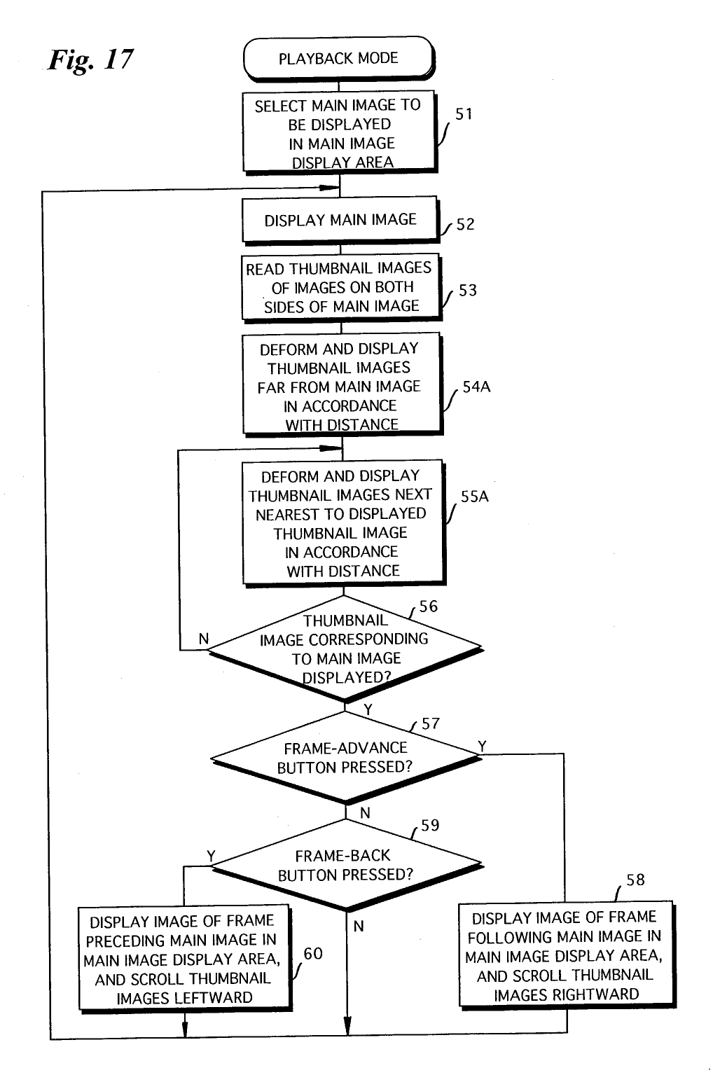

FIGS. 16 and 17 illustrate a third modification of the above embodiment.

FIG. 16 is a diagram illustrating examples of images displayed on the display screen.

As shown in FIG. 16, a main image display area 31A is displayed at the center of the display screen 30. An index image display area 40A is displayed so as to encircle the lower part of the main image display area 31A.

The index image display area 40A has the shape of a cylinder, which has a prescribed height, when looked down upon obliquely from above.

Since the index image display area 40A is construed as being a cylinder, it has an outer circumferential surface and an inner circumferential surface. The index image display area 40A is formed to have a plurality of thumbnail image display areas 73 to 77 on the outer circumferential surface on the side in front of the main image display area 31A and a plurality of thumbnail image display areas 71, 72, 78 and 79 on the inner circumferential surface on the side in back of the main image display area 31A. Displayed in these thumbnail image display areas are the corresponding thumbnail images i1 to i9. A thumbnail image that corresponds to the main image being displayed in the main image display area 31A is displayed in a center thumbnail image display area 75 on the outer circumferential surface on the side in front.

As will be described later, each thumbnail image to be displayed in thumbnail image display areas 73 to 77, 71, 72, 78 and 79 of the index image display area 40A is caused to be displayed in the neighboring thumbnail image display area on the left or right side in response to application of a frame-advance command or frame-back command.

FIG. 17 is a flowchart illustrating processing in the playback mode. Processing steps in FIG. 17 identical with those of FIG. 4 are designated by like step numbers and need not be described again.

The processing shown in FIG. 17 has processing indicated by steps 54A and 55A instead of the processing indicated by steps 54 and 55 in FIG. 4.

When thumbnail image data is read from the memory card 22 (step 53), the thumbnail image corresponding to the main image being displayed in the main image display area 31A is displayed in the center thumbnail image display area 75. Thumbnail image data is processed in such a manner that the corresponding thumbnail image is deformed in accordance with distance from the center thumbnail image display area 75 (distance along the circumference) (step 54A). The deformed thumbnail images are displayed in the thumbnail image display areas in order of decreasing distance from the center thumbnail image display area 75 (step 55A). This control for displaying thumbnail images is repeated until the thumbnail image that corresponds to the main image display area 31A is displayed in the center thumbnail image display area 75 (step 56).

The image displayed in the main image display area 31A changes, and each thumbnail image displayed in the index image display area 40A is caused to be displayed in a thumbnail image display area on the left or right side, in accordance with whether the frame-advance button or frame-back button is pressed. This is as set forth above.

In the above-described embodiment, the main image being displayed in the main image display area 31A (30) changes, and so do the thumbnail images displayed in the index image display area 40A (30), in response to depression of the frame-advance button or frame-back button. However the jog dial 20 can also be utilized, as mentioned above. In dependence upon the direction in which the jog dial 20 is turned, frames are moved ahead or back by an amount corresponding to the angle through which the jog dial 20 is turned. Thumbnail images corresponding to the angle of rotation of the jog dial 20 are displayed in the thumbnail image display areas and the main image is displayed in the main image display area.

As many apparently widely different embodiments of the present invention can be made without departing from the spirit and scope thereof, it is to be understood that the invention is not limited to the specific embodiments thereof except as defined in the appended claims.

What is claimed is:

1. An apparatus for controlling display of index images, comprising:
a first display controller for controlling a display device so as to display an image display strip on a display screen, said image display strip including a plurality of mutually adjacent image display areas the sizes of which diminish in accordance with direction along the image display strip as distance from one of the image display areas increases;
an image data reading device for reading a plurality of frames of image data that have been recorded on a recording medium;
a second display controller for controlling the display device in such a manner that a plurality of frames of images represented by the plurality of frames of image data, which have been read by said image data reading device, are displayed in corresponding ones of the image display areas of the image display strip.

2. The apparatus according to claim 1, further comprising a reducing device for reducing the image data of the plurality of frames, which have been read by said image data reading device, in such a manner that the sizes of the images displayed in the image display areas are reduced in accordance with direction along the image display strip;
said second display controller displaying thumbnail images, which are represented by the image data reduced by said reducing device, in the corresponding image display areas.

3. The apparatus according to claim 1, wherein the image display strip is ring-shaped, said apparatus further comprising:
a scroll command input device; and
a third display controller for controlling the display device, in response to entry of a scroll command from said scroll command input device, in such a manner that images to be displayed in the image display areas are displayed one after another in mutually adjacent image display areas.

4. The apparatus according to claim 1, wherein said second display controller controls the display device in such a manner that a part of image is displayed on the image display area.

5. The apparatus according to claim 4, wherein the part of image includes a center portion of the image.
